(19) United States
(12) Patent Application Publication
(10) Pub. No.: US 2014/0265925 A1
(43) Pub. Date: Sep. 18, 2014

(54) LED BACKLIGHT DRIVING CIRCUIT, LCD DEVICE, AND METHOD FOR DRIVING THE LED BACKLIGHT DRVING CIRCUIT

(71) Applicant: SHENZHEN CHINA STAR OPTOELECTRONICS TECHNOLOGY CO., LTD., Shenzhen (CN)

(72) Inventors: Hua Zhang, Shenzhen (CN); Fei Li, Shenzhen (CN)

(21) Appl. No.: 13/880,741

(22) PCT Filed: Mar. 15, 2013
(86) PCT No.: PCT/CN2013/072720

§ 371 Date: Apr. 22, 2013

(30) Foreign Application Priority Data
Mar. 14, 2013 (CN) 201310081767.7

(51) Int. Cl. H05B 33/08

(52) U.S. Cl. CPC H05B 33/0815
USPC 315/297

(57) ABSTRACT

The present disclosure provides a light emitting diode (LED) backlight driving circuit, a liquid crystal display (LCD) device, and a method for driving the LED backlight driving circuit. The LED backlight driving circuit includes an odd number of LED lightbars and a constant current driver chip including an even number of channels. The channels include a work channel connected to the LED lightbar, and a dangling channel that is not connected to the LED lightbar. The dangling channel is connected to a reference signal, and a voltage of the reference signal is more than an internal comparison voltage of the constant current driver chip.

### TECHNICAL FIELD

The present disclosure relates to die field of a liquid crystal display (LCD), and more particularly to a light emitting diode (LED) backlight driving circuit, an LCD device, and a method for driving the LED backlight driving circuit.

### BACKGROUND

As shown in FIG. 1, a typical liquid crystal display (LCD) generally uses a light emitting diode (LED) as a light source. The light source is an LED lightbar formed by a plurality of LEDs connected in series. Each of the LED lightbars is connected to a corresponding channel of a constant current driver chip. Generally, a typical multiple-channel constant current driver chip has an even number of channels, namely the typical multiple-channel constant current driver chip controls current of the even number of LED lightbars. The constant current driver chip includes all kinds of detection modules. When the detection module detects an abnormal condition, the constant current driver chip performs a corresponding protection function. When there is an odd number of the LED lightbars, some channels are not connected to the LED lightbar, namely the channels are in a dangling state, thus when the constant current driver chip performs the protection function, there is an increased, output voltage and an abnormal backlight display of an LED backlight driving circuit.

### SUMMARY

In view of the above-described problems, the aim of the present disclosure is to provide a light emitting diode (LED) backlight driving circuit, a liquid crystal display (LCD) device, and a method for driving the LED backlight driving circuit capable of solving an abnormal backlight display when the LED backlight driving circuit comprises an odd number of LED lightbars and a constant current driver chip having an even number of channels.

The aim of the present disclosure is achieved by the following method.

An LED backlight driving circuit comprises an odd number of LED lightbars and a constant current driver chip having an even number of channels. The channels comprise a work channel connected to the LED lightbar, and a dangling channel not connected to the LED lightbar. The dangling channel is connected to a reference signal, and a voltage of the reference, signal is more than an internal comparison voltage of the constant current driver chip.

In one example, the reference signal comprises a triangle-waved signal setting a driving frequency of the LED backlight driving circuit. This is a first reference signal.

In one example, the reference signal comprises a constant voltage signal comparing a reference of a voltage of the LED backlight driving circuit. This is a second reference signal.

In one example, the reference signal comprises a square-waved signal dimming light of the LED lightbars. This is a third reference signal.

In one example, the constant current driver chip comprises a comparison module. The internal comparison voltage of the constant current driver chip is coupled to a non-inverting input of the comparison module, and the channel of the constant current driver chip is coupled to inverting inputs of the comparison module. Each of the inverting input of the comparison module is coupled to a corresponding channel of the constant current driver chip. This is a specific circuit structure of the constant current driver chip. The constant current driver chip detects a voltage change of the LED lightbar through the comparison module, then adjusts a driving output according to the detection and adjusts an output voltage of the LED backlight driving circuit.

In one example, the LED backlight driving circuit comprises an inductor coupled to a power source end of the LED backlight driving circuit, and a rectifier diode connected in series between the inductor and the LED lightbars. An anode of the rectifier diode is coupled to the inductor and a ground terminal by a controllable switch. A cathode of the rectifier diode is coupled to an anode of the LED lightbar.

The constant current driver chip further comprises a control module, and comparison data between the non-inverting input and the inverting input of the comparison module is transferred to the control module, the control module outputs a driving signal to a control end of the controllable switch according to the comparison data. This is a special circuit structure of the LED backlight driving circuit.

In one example, each of the channels of the constant current driver chip is configured with a dimmer switch, a current-limiting resistor connected in series between the dimmer switch and the ground terminal, and an operational amplifier coupled to the dimmer switch. A first input end of the operational amplifier is connected to a reference voltage, and a second input end of the operational amplifier is connected to an output end of the dimmer switch. This is a special circuit structure of the constant current driver chip, the operational amplifier feeds back a current of the LED lightbars to dim light of the LED lightbars automatically.

A liquid crystal display (LCD) device comprises an LED backlight driving circuit of the present disclosure.

A method for driving an LED backlight driving circuit of the present disclosure comprises: connecting a reference signal to a dangling channel of the constant current driver chip, and a voltage of the reference signal is mote than an internal comparison voltage of the constant current driver chip.

In one example, the reference signal comprises a triangle-waved signal setting a driving frequency of the LED backlight driving circuit, a constant voltage signal comparing a reference of a voltage of the LED backlight driving circuit, or a square-waved signal dimming light of the LED lightbars. This is a specific type of the reference signal.

Generally, a typical constant current driver chip basically has an open circuit protection function of the LED lightbars. The constant current driver chip may detect a cathode voltage of the LED lightbars, then compare the cathode voltage of the LED lightbar with the internal constant voltage of the constant current driver chip. When one of the LED lightbars turns off, a detection pin of the constant current driver chip corresponding to the LED lightbar has no voltage, and the comparison module outputs a high voltage to the control module, the constant current driver chip determines that the cathode voltage of the LED lightbar is low because an output voltage of the LED backlight driving circuit is not enough, thus the control module increases a duty ratio of a driving signal of a metal-oxide-semiconductor field-effect transistor (MOSFET), and the output voltage of the LED backlight driving circuit is increased, which results in an abnormal backlight display of the LED backlight driving circuit.

When one of the LED lightbars is not connected to the channel of the constant current driver chip, the reference signal is connected to the detection pin of the channel of the constant current driver chip that is not connected to the LED lightbar, the voltage of the reference signal is more than the internal comparison voltage of the constant current driver chip. Since the voltage of the reference signal is very stable, and is more than the internal comparison voltage of the constant current driver chip, the comparison module outputs a low voltage, the constant current driver chip determines that the channel is normal, and does not perform protection function, the output voltage of the constant current driver chip is not high, thus the LED backlight driving circuit having the odd number of LED lightbars may normally work, which avoids the abnormal backlight display of the LED backlight driving circuit.

### BRIEF DESCRIPTION OF FIGURES

FIG. 1 is a schematic diagram of a light emitting diode (LED) backlight driving circuit of the prior art;

FIG. 2 is a schematic diagram of a light emitting diode (LED) backlight driving circuit of an example of the present disclosure; and

FIG. 3 is a schematic diagram of a method for driving an LED backlight driving circuit of an example of the present disclosure.

Legends: 10. LED lightbar, 20. constant current driver chip, 21. work channel, 22. dangling channel, 23. comparison module, 24. control module, 25. Channel, 30. reference signal.

### DETAILED DESCRIPTION

The present, disclosure, provides a liquid crystal display (LCD) device comprising a light emitting diode (LED) backlight driving circuit. The LED backlight driving circuit comprises an odd number of LED lightbars 10 and a constant current driver chip 20 having an even number of channels 25. The channels 25 comprise a work channel 21 connected to the LED lightbar 10 and a dangling channel 22 that is not connected to the LED lightbar 10. The dangling channel 22 is connected to a reference signal 30, and a voltage of the reference signal 30 is more than an internal comparison voltage of the constant current driver chip 20.

Generally, a typical constant current driver chip 20 has an open circuit protection function of the LED lightbar 10. In the open protection function, the constant current driver chip 20 may detect a cathode voltage of the LED lightbar 10, and compare the cathode voltage of the LED lightbar 10 with an internal constant voltage of the constant current driver chip 20. When one of the LED lightbars 10 turns off, a detection pin of the constant current driver chip 20 corresponding to the LED lightbar 10 has no voltage, and a comparison module 23 outputs a high voltage to a control module 24, the constant current driver chip 20 determines that the cathode voltage of the LED lightbar is low because an output voltage of the LED backlight driving circuit is not enough, thus the control module 24 increases a duty ratio of a driving signal of a metal-oxide-semiconductor field-effect transistor (MOSFET), and the output voltage of the LED backlight driving circuit is increased, which results in an abnormal backlight display of the LED backlight driving circuit.

When one of the LED lightbars 10 is not connected to the channel 25 of the constant current driver chip 20, the reference signal 30 is connected to the detection pin of the channel 25 of the constant current driver chip 20 that is not connected to the LED lightbar, the voltage of the reference signal 30 is more than the internal comparison voltage of the constant current driver chip 20. Since the voltage of the reference signal 30 is very stable, and is more than the internal comparison voltage of the constant current driver chip 20, the comparison module outputs a low voltage, the constant current driver chip 20 determines that the channel is normal, and does not perform the protection function, the output voltage of the constant current driver chip is not high, thus the LED backlight driving circuit having the odd number of LED lightbars 10 may normally work, which avoids the abnormal backlight display of the LED backlight driving circuit.

The present disclosure will further be described in detail in accordance with the figures and the exemplary examples.

As shown in FIG. 2, an LED backlight driving circuit of the present disclosure comprises an odd number of LED lightbars 10 and a constant current driver chip 20 having an even, number of channels 25. The channels 25 comprise a work channel 21 connected to the LED lightbar 10, and a dangling channel 22 not connected to the LED lightbar 10. The dangling channel 22 is connected to a reference signal, and a voltage of the reference signal 30 is more than an internal comparison voltage of the constant current driver chip 20. The reference signal 30 comprises but is not limited to a triangle-waved signal RT setting a driving frequency of the LED backlight driving circuit, a constant voltage signal VREF comparing a reference of a voltage of the LED backlight driving circuit or a square-waved signal PWM dimming light of the LED lightbars 10.

The LED backlight driving circuit comprises an inductor L1 coupled to a power source end of the LED backlight driving circuit, and a rectifier diode D1 connected in series between the inductor L1 and the LED lightbars 10, where an anode of the rectifier diode D1 is coupled to the inductor L1 and a ground terminal by a controllable switch MOSFET. A cathode of the rectifier diode D1 is coupled to an anode of the LED lightbar 10. The constant current driver chip 20 comprises a comparison module 23 and a control module 24. The internal comparison voltage of the constant current driver chip 20 is coupled to a non-inverting input of the comparison module 23, and the channel 25 of the constant current driver chip 20 is coupled to inverting inputs of the comparison module 23. Each of the inverting input of the comparison module 23 is coupled to a corresponding channel 25 of the constant current driver chip 20. Comparison data between the non-inverting input and the inverting input of the comparison module 23 is transferred to the control module 24, where the control module 24 outputs a driving signal to a control end of the controllable switch according to the comparison data.

The channel 25 of the constant current driver chip 20 comprises a dimmer switch Q, a current-limiting resistor R connected in series between the dimmer switch Q and the ground terminal, and an operational amplifier OP coupled to the dimmer switch Q. A first input end of the operational amplifier OP is connected to a reference voltage V0, and a second input end of the operational amplifier OP is connected to an output-end of the dimmer switch Q.

The present disclosure provides a special circuit structure of the LED backlight driving circuit. The constant current driver chip 20 detects a voltage change of the LED lightbars 10 through the comparison module 23, then adjusts a driving output according to the detection and adjusts an output voltage of the LED backlight driving circuit. The constant current driver chip 20 dims light of the LED lightbar 10 automatically through a current of the LED lightbars 10 fed back by the operational amplifier OP.

As shown in FIG. 3, the present disclosure provides a method for driving an LED backlight driving circuit. The method comprises: connecting a reference signal 30 to a dangling channel 22 of a constant current driver chip 20, where a voltage of the reference signal 30 is more than an internal comparison voltage of the constant current driver chip 20. The reference signal 30 comprises but is not limited to a triangle-waved signal RT setting a driving frequency of the LED backlight driving circuit, a constant voltage signal VREF comparing a reference of a voltage of the LED backlight driving circuit, or a square-waved signal PWM dimming light of the LED lightbar 10.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A light emitting diode (LED) backlight driving circuit, comprising:
an odd number of LED lightbars; and
a constant current driver chip having an even number of channels;
wherein the channels comprise a work channel connected to the LED lightbar, and a dangling channel not connected to the LED lightbar; the dangling channel is connected to a reference signal, and a voltage of the reference signal is more than an internal comparison voltage of the constant current driver chip.

2. The LED backlight driving circuit of claim 1, wherein the constant current driver chip comprises a comparison module; the internal comparison voltage of the constant current driver chip is coupled to a non-inverting input of the comparison module, and the channel of the constant current driver chip is coupled to inverting inputs of the comparison module; wherein each of the inverting input of the comparison module is coupled to a corresponding channel of the constant current driver chip.

3. The LED backlight driving circuit of claim 2, wherein the LED backlight driving circuit comprises an inductor coupled to a power source end of the LED backlight driving circuit, and a rectifier diode connected in series between the inductor and the LED lightbars; an anode of the rectifier diode is coupled to the inductor and a ground terminal by a controllable switch; a cathode of the rectifier diode is coupled to an anode of the LED lightbars;
wherein the constant current driver chip further comprises a control module, comparison data between the non-inverting input and the inverting input of the comparison module is transferred to the control module; the control module outputs a driving signal to a control end of the controllable switch according to the comparison data.

4. The LED backlight driving circuit of claim 3, wherein the channel of the constant current driver chip is configured with a dimmer switch, a current-limiting resistor connected in series between the dimmer switch and the ground terminal, and an operational amplifier coupled to the dimmer switch; a first input end of the operational amplifier is connected to a reference voltage, a second input end of the operational amplifier is connected to an output end of the dimmer switch.

5. The LED backlight driving circuit of claim 1, wherein the reference signal comprises a triangle-waved signal setting a driving frequency of the LED backlight driving circuit.

6. The LED backlight driving circuit of claim 5, wherein the constant current driver chip comprises a comparison module; the internal comparison voltage of the constant current driver chip is coupled to a non-inverting input of the comparison module, and the channel of the constant current driver chip is coupled to inverting inputs of the comparison module; and each of the inverting input of the comparison module is coupled to a corresponding channel of the constant current driver chip.

7. The LED backlight driving circuit of claim 1, wherein the reference signal comprises a constant voltage signal comparing a reference of a voltage of the LED backlight driving circuit.

8. The LED backlight driving circuit of claim 7, wherein the constant current driver chip comprises a comparison module; the internal comparison voltage of the constant current driver chip is coupled to a non-inverting input of the comparison module, and the channel of the constant current driver chip is coupled to inverting inputs of the comparison module; and each of the inverting input of the comparison module is coupled to a corresponding channel of the constant current driver chip.

9. The LED backlight driving circuit of claim 1, wherein the reference signal comprises a square-waved signal dimming light of the LED lightbar.

10. The LED backlight driving circuit of claim 9, wherein the constant current driver chip comprises a comparison module; the internal comparison voltage of the constant current driver chip is coupled to a non-inverting input of the comparison module, and the channel of the constant current driver chip is coupled to inverting inputs of the comparison module; and each of the inverting input of the comparison module is coupled to a corresponding channel of the constant current driver chip.

11. A liquid crystal display (LCD) device, comprising:
a light emitting diode (LED) backlight driving circuit;
wherein the LED backlight driving circuit comprises an odd number of LED lightbars and a constant current driver chip having an even number of channels; the channels comprise a work channel connected to the LED lightbar, and a dangling channel not connected to the LED lightbar; the dangling channel is connected to a reference signal, and a voltage of the reference signal is more than an internal comparison voltage of the constant current driver chip.

12. The LCD device of claim 11, wherein the constant current driver chip comprises a comparison module; the internal comparison voltage of the constant current driver chip is coupled to a non-inverting input of the comparison module, and the channel of the constant current driver chip is coupled to inverting inputs of the comparison module; wherein each of the inverting input of the comparison module is coupled to a corresponding channel of the constant current driver chip.

13. The LCD device of claim 12, wherein the LED backlight driving circuit comprises an inductor coupled to a power source end of the LED backlight driving circuit, and a rectifier diode connected in series between the inductor and the LED lightbars; an anode of the rectifier diode is coupled to the inductor and a ground terminal by a controllable switch; a cathode of the rectifier diode is coupled to an anode of the LED lightbars;
wherein the constant current driver chip further comprises a control module, comparison data between the non-inverting input and the inverting input of the comparison module is transferred to the control module; the control module outputs a driving signal to a control end of the controllable switch according to the comparison data.

14. The LCD device of claim 13, wherein the channel of the constant current driver chip is configured with a dimmer switch, a current-limiting resistor connected in series between the dimmer switch and the ground terminal, and an operational amplifier coupled to the dimmer switch; a first input end of the operational amplifier is connected to a reference voltage, a second input end of the operational amplifier is connected to an output end of the dimmer switch.

15. The LCD device of claim 11, wherein the reference signal comprises a triangle-waved signal setting a driving frequency of the LED backlight driving circuit, a constant voltage signal comparing a reference of a voltage of the LED backlight driving circuit, or a square-waved signal dimming light of the LED lightbars.

16. The LCD device of claim 15, wherein the constant current driver chip comprises a comparison module; the internal comparison voltage of the constant current driver chip is coupled to a non-inverting input of the comparison module, and the channel of the constant current driver chip is coupled to inverting inputs of the comparison module; and each of the inverting input of the comparison module is coupled to a corresponding channel of the constant current driver chip.

17. The LCD device of claim 16, wherein the LED backlight driving circuit comprises an inductor coupled to a power source end of the LED backlight driving circuit, and a rectifier diode connected in series between the inductor and the LED lightbars; an anode of the rectifier diode is coupled to the inductor and a ground terminal by a controllable switch; a cathode of the rectifier diode is coupled to an anode of the LED lightbars;
wherein the constant current driver chip further comprises a control module, comparison data between the non-inverting input and the inverting input of the comparison module is transferred to the control module; the control module outputs a driving signal to a control end of the controllable switch according to the comparison data.

18. The LCD device of claim 17, wherein the channel of the constant current driver chip is configured with a dimmer switch, a current-limiting resistor connected in series between the dimmer switch and the ground terminal, and an operational amplifier coupled to the dimmer switch; a first input end of the operational amplifier is connected to a reference voltage, a second input end of the operational amplifier is connected to an output end of the dimmer switch.

19. A method for driving an LED backlight driving circuit, the LED backlight driving circuit comprising an odd number of LED lightbars and a constant current driver chip having an even number of channels, the channels comprising a work channel connected to the LED lightbar and a dangling channel not connected to the LED lightbar; the dangling channel connected to a reference signal, and a voltage of the reference signal being more than an internal comparison voltage of the constant current driver chip, the method comprising:
connecting the reference signal to the dangling channel of the constant current driver chip, the voltage of the reference signal is more than the internal comparison voltage of the constant current driver chip.

20. The method for driving the LED backlight driving circuit of claim 19, wherein the reference signal comprises a triangle-waved signal setting a driving frequency of the LED backlight driving circuit, a constant voltage signal comparing a reference of a voltage of the LED backlight driving circuit, or a square-waved signal dimming light of the LED lightbars.
